(19) United States
(12) Patent Application Publication
(10) Pub. No.: US 2016/0045983 A1
(43) Pub. Date: Feb. 18, 2016

(54) METHOD OF LASER PROCESSING OF VOLATILE ALLOYS

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/459,583

(22) Filed: Aug. 14, 2014

(51) Int. Cl. B23K 26/34; B23K 26/00; B23K 26/18; B23K 35/36; B23K 26/12

(52) U.S. Cl. CPC B23K 26/34; B23K 35/3602; B23K 35/3607; B23K 35/361; B23K 35/3608; B23K 26/123; B23K 26/18; B23K 26/0009; B23K 26/0039

(57) ABSTRACT

The present invention relates to flux compositions and methods for laser processing volatile alloys. A flux composition contains a metal oxide, a metal silicate, or both; a shielding agent which forms at least one gas upon heating; and a plasma-generating agent, but not a metal fluoride. A process involves applying an energy beam (10) to a flux composition (6) such that the flux composition reacts to form a plasma (14) and a shielding gas (18). An amount of energy applied to the flux composition is controlled to convert the flux composition into a molten slag blanket (16) in the presence of the shielding gas without completely melting an alloy material (4) situated below the flux composition. The molten slag blanket then heats the alloy material by thermal conduction in the presence of the shielding gas to form a pressurized melt pool (22) of the alloy material, which cool and solidifies.

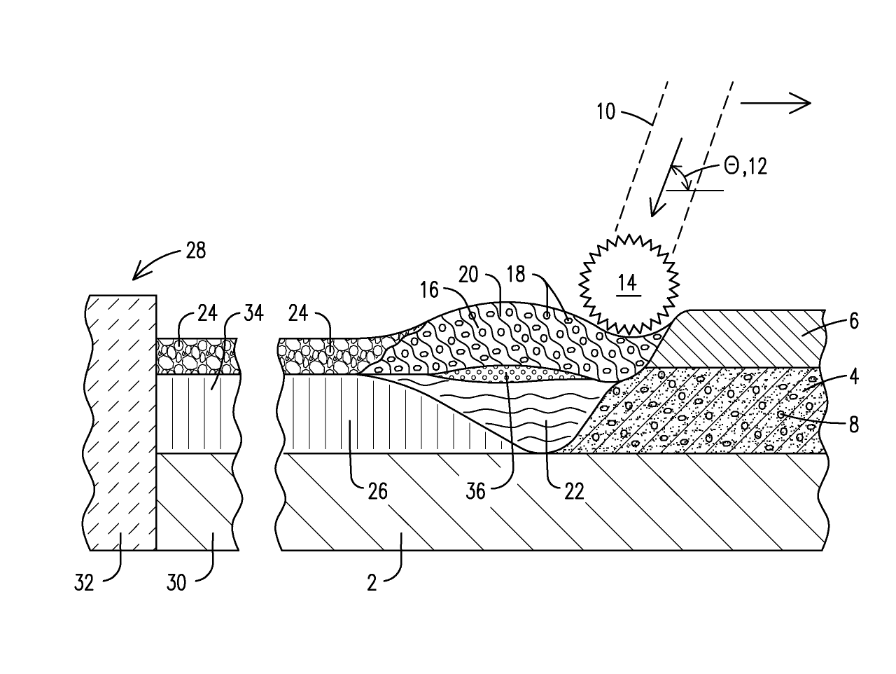

### FIELD OF THE INVENTION

This application relates to materials technology in general and more specifically to laser processing of volatile alloys including magnesium alloys.

### BACKGROUND OF THE INVENTION

Magnesium is the most abundant element on earth and is used in a large variety of industries such as the automotive, aerospace, power generation and medical industries. Recently, alloys of magnesium have attracted great attention for their potential use as bioresorbable implants which can offer tailored degradation behavior for osteo-synthesis or vascular applications. However, the utility of magnesium alloys as well as other alloys containing volatile elements (e.g., Zn, Cd, Se, Na, K, Sb, Pb) is hampered by their properties.

Magnesium has a melting point of only 649° C. and boiling point of 1090° C., such that processes involving the melting of magnesium alloys tend to cause volatilization and loss of magnesium as a component in the resulting (re-solidified) alloys. Magnesium also reacts readily with oxygen leading to inclusions in alloys subjected to welding processes. In powdered form magnesium can combust if heated in air. Alloys containing magnesium also tend to become porous when melted for prolonged periods due to coalescence of dissolved or formed gases such as nitrogen and hydrogen. Welding processes involving magnesium also tend to suffer from mechanical imperfections including distortion (due to high coefficients of thermal expansion and conductivity), solidification cracking, and heat affected zone (HAZ) liquation cracking.

Magnesium alloys are normally welded using the inert gas tungsten arc welding or tungsten inert gas) process (GTAW or TIG). However, because processes such as GTAW involve relatively high heat input, the application of this and other high temperature melting techniques to magnesium alloys often results in weld cracking with liquation cracking initiating at the HAZ and extending into the weld metal (especially under conditions of restraint).

Laser welding has been investigated as an alternative to processes such as GTAW. It is known, for example, to use laser cladding to impart increased strength and corrosion resistance to magnesium alloys by depositing a wear-resistance or corrosion-resistance cladding layer (e.g., ODS alloy). It is also known to use laser welding to join magnesium alloys, in which certain activating substances may be applied to the surface of the alloys to increase penetration of the laser energy.

The use of laser additive manufacturing (LAM) has also been investigated as a possible method for manufacturing three-dimensional objects of magnesium alloys. See, e.g., Nolke et al., “Progress in 3D: Future of Medical Implants,” LIA Today (January/February 2014). It was reported, however, that the resulting magnesium alloy objects suffered from excessive porosity even when LAM was performed under a pressure of 2 bar.

### BRIEF DESCRIPTION OF THE DRAWINGS

The invention is explained in the following description in view of the sole FIGURE which illustrates a method for laser processing of volatile alloys.

### DETAILED DESCRIPTION OF THE INVENTION

The present inventors have recognized that a need exists to discover methods and materials for producing and processing volatile alloys which, due to the presence of easily-volatilized and often reactive metallic components, tend to form porous alloys containing mechanical and chemical imperfections when subjected to known melting processes. Ideal methods and materials would enable volatile alloys to be deposited, cast, joined, coated and modified (e.g., dispersion strengthened) without forming the unwanted pores, inclusions, and cracking described above—while at the same time avoiding the need to employ rigorously air-free or pressure controlled conditions (e.g., use of expensive inert gases) or pressure chambers.

The term “volatile alloys” is used herein in a general sense to describe alloys of low boiling temperature (e.g. less than 1800° C.) and/or containing low melting point constituents such as a metal selected from magnesium, zinc, cadmium, selenium, sodium, potassium, antimony and lead. These metals are described as being “volatile” due to their relatively low melting and boiling points. Under conditions of laser melting, the composition of alloys containing these metals may be altered due to loss of the volatile metals through evaporation. Volatilization also exacerbates oxidation of highly reactive metals such as magnesium and zinc when laser melting occurs in the presence of oxygen. Consequently, performing laser processing on alloys containing reactive metals (or easily volatilized metals) such as magnesium based alloys, zinc based alloys, aluminum alloys containing magnesium (e.g. 5042, 5182), copper alloys containing cadmium (e.g. C16200, C16210), and copper alloys containing zinc and/or lead (e.g. bronzes, brasses, “nickel silvers”), often introduces oxide-containing inclusions (or voids) into the resulting alloys.

It was discovered by the present inventors that volatile alloys may be produced and processed—without introducing excessive porosity, inclusions and mechanical imperfections such as liquation cracking—by employing novel laser melting techniques using specialized flux compositions. Process conditions for laser melting are modified to allow greater control of heat applied to the volatile alloy, in order to minimize superheating and volatilization of the melted alloy. In some embodiments this control of laser heating enables melting of the volatile alloys by conduction heating as opposed to the high power density radiant heating typically associated with laser melting processes such as laser key-hole welding. Specialized plasma-forming flux compositions are also employed which can react upon heating to produce shielding gases and molten slags, which protect the melted alloy from oxidation, and to form a viscous slag blanket adapted to reduce volatilization of the melted alloy. In some embodiments the combination of the shielding gas and the viscous slag blanket provides a blanket with temporary overpressure to further reduce volatilization of the melted alloy.

The FIGURE illustrates an exemplary method for laser processing of a magnesium alloy. In this non-limiting example an alloy containing material 4 is supported upon the surface of a support material 2. This alloy containing material 4 contains a volatile (Mg) alloy 8, and is covered by a layer of a flux composition 6. An energy beam 10 is then applied to the surface of the flux composition 6 causing it to form a plasma 14 and a molten slag blanket 16 containing at least one shielding gas 18 (e.g. CO, CO₂). Heat from the molten slag blanket 16 is then transmitted via conduction to the alloy containing material 4 causing it to melt and form a melt pool 22. The molten slag blanket 16 is then allowed to cool and solidify to form a solidified slag crust 24. The underlying melt pool 22 also cools to form a solidified alloy 26 containing the volatile (Mg) alloy 8.

In the exemplary process of the FIGURE the flux composition 6 and molten slag blanket 16 provide a number of functions that are beneficial to improve the chemical and mechanical properties of the resulting solidified alloy 26.

First, they function to shield both the region of melt pool 22 and the solidified (but still hot) alloy 26 from the atmosphere in the region downstream of the energy beam 10. The slag floats to the surface to separate the molten or hot metal from the atmosphere, and the flux may be formulated to produce at least one shielding gas 18 as described above, thereby avoiding or minimizing the use of expensive inert gas.

Second, the molten slag blanket 16 acts as an insulation layer that allows the solidified material to cool slowly and evenly, thereby reducing residual stresses that can contribute to post weld cracking, and reheat or strain age cracking. Such slag blanketing over and adjacent to the alloy deposit can further enhance heat conduction towards the support material 2 which in some embodiments can promote directional solidification to form elongated grains in the solidified alloy 26.

Third, the molten slag blanket 16 helps to shape and support the melt pool 22 to keep it close to a desired height/width ratio (e.g., a 1/3 height/width ratio). This shape control and support further reduces solidification stresses that could otherwise be imparted to the solidifying alloy.

Fourth, the molten slag blanket 16 provides a cleansing effect for removing trace impurities such as so-called TRAMP elements (e.g. (for magnesium-based alloys) Ca, Ce, Li, Na and Yt) that contribute to inferior properties. Such cleansing may include deoxidation of the alloy containing material 4. Because the flux composition 6 is in intimate contact with the alloy containing material 4, it is especially effective in accomplishing this function.

Fifth, the molten slag blanket 16 can serve as a heat source to transmit heat energy to the alloy containing material 4 leading to melting and formation of the melt pool 22. It may also provide an energy absorption and trapping function to more effectively convert the energy beam 10 into heat energy, thus facilitating a precise control of heat input to the alloy containing material 4. Additionally, the flux composition 6 may be formulated to compensate for loss of volatized or reacted elements during processing or to actively contribute elements to the deposit that are not otherwise provided by the alloy containing material 4. An important example of this function is replenishment of magnesium in magnesium aluminum alloys. In particular, it has been reported (see Zhou et al., “Hot cracking in tungsten inert gas welding of magnesium alloy AZ₉₁D”, 2007) that, due to its high vapor pressure, loss of magnesium during welding creates an imbalance in the aluminum to magnesium content leading to low melting eutectic formation (e.g., Mg₁₇Al₁₂) and liquation cracking in the heat affected zone and extending into the weld metal. Therefore, a flux formulated to limit such vaporization and/or a flux providing compensation for magnesium loss can be important to avoid weld cracking in some embodiments.

The method of the FIGURE incorporates a number of novel features enabling the production and processing of volatile alloys without introducing excessive porosity, inclusions and mechanical imperfections such as cracking.

First, it employs a flux composition 6 that reacts upon heating to form the plasma 14 and the shielding gas 18. The plasma 14 serves two functions. It absorbs energy from the energy beam 10 to reduce (moderate) radiant heating of the molten slag blanket 16 and, thereby, indirectly reduces radiant heating of the alloy containing material 4 and the melt pool 22. The plasma also applies a pressure to the surface of the molten slag blanket 16 contributing to a temporary pressurization of the melt pool 22. The shielding gas typically contains carbon monoxide, carbon dioxide, or both. However, in some embodiments the shielding gas may contain hydrogen. The shielding gas protects the melt pool 22 from atmospheric gases such as oxygen, and it also provides a positive pressure that reduces volatilization of volatile elements in the melt pool 22.

The flux composition 6 may also be formulated to enhance pressurization of the melt pool 22 and to minimize direct radiant heating of the melt pool 22. To enhance pressurization the flux composition 6 is formulated so that the corresponding molten slag blanket 16 exhibits an increased viscosity relative to molten slag layers produced by known flux materials. Increased viscosity tends to increase pressure on the melt pool 22 by reducing gas permeability allowing a higher pressure to form under the molten slag blanket 16. In some embodiments the viscosity of the molten slag blanket 16 is increased by adding one or more viscosity enhancers to the flux composition 6 (e.g. acidic oxides such as silicates, and amphoteric oxides such as alumina and titania). In some cases the relative viscosity of the molten slag blanket 16 is increased by excluding fluidity enhancers (e.g. fluorides) and some basic oxides (e.g. calcia, magnesia, Na₂O and K₂O) from the flux composition 6. Such fluidity enhancers are commonly added to known flux materials to reduce viscosity and to increase wettability. In some instances the flux composition 6 includes organic polymers or resins that reduce gas permeability in the resulting molten slag blanket 16 by forming an organic barrier.

In some embodiments the flux composition 6 may be formulated to contain a high-temperature metal oxide capable of increasing the viscosity and/or reducing the gas permeability of the molten slag blanket 16. Suitable high-temperature metal oxides include metal oxide compounds having melting points equal to or greater than 2100° C.—such as Sc₂O₃, Cr₂O₃, Y₂O₃, ZrO₂, HfO₂, La₂O₃, Ce₂O₃, Al₂O₃, TiO₂FeO, MnO and CeO₂. It is believed that inclusion of at least one high-temperature metal oxide can enhance pressurization of the melt pool 22 by causing more rapid solidification of the molten slag blanket 16. In some instances, inclusion of at least one high-temperature metal oxide can lead to the rapid formation of an oxide crust on the surface of the molten slag blanket 16. It is believed that such crusting may increase pressure on the melt pool 22 by at least partially restricting the escape of shielding gases 18 contained in and under the molten slag blanket 16.

Increasing viscosity of the flux composition 6 may reduce the formation of oxide inclusions due to a more effective shielding of the melt pool 22 from atmospheric oxygen by the molten slag blanket 16. In some embodiments, use of the flux composition 6 may provide adequate protection from the atmosphere (to reduce the occurrence of oxidation and inclusions) without the formation of a shielding gas 18. In such cases the flux composition 6 may omit the shielding agents (i.e., gas-generating agents) contained in other flux compositions of the present disclosure.

The flux composition 6 may also be formulated to reduce direct radiant heating of the alloy containing material 4 and the melt pool 22. This may be accomplished by employing a powdered flux composition 6 wherein the size and shape of the flux powder affects absorption of the energy beam 10. As the size and aspect ratio of flux composition particles decreases, absorption of the energy beam in the flux composition increases—causing a corresponding reduction in radiant energy heating of the alloy containing material 4 and the melt pool 22. Consequently, in some embodiments the size and shape of flux particles may be adjusted such that the energy beam (and plasma) directly heats the flux composition 6 and the molten slag blanket 16 but does not substantially heat the alloy containing material 4 and the melt pool 22 through radiant heating. In such embodiments the alloy containing material 4 is indirectly heated by the molten slag blanket 16 through conduction heating—such that the molten slag blanket 16 and the melt pool 22 form distinct molten layers (as illustrated in the FIGURE).

Whereas commercial fluxes generally range in average particle size from about 0.5 mm to about 2 mm (500-2000 microns) in diameter (or approximate dimension if not rounded), flux compositions in some embodiments of the present disclosure range in average particle size from about 0.005 mm to about 0.10 mm (5 to 100 microns) in diameter. In some cases the average particle size ranges from about 0.01 mm to about 5 mm, or from about 0.05 mm to about 2 mm. In some cases the average particle size ranges from about 0.1 mm to about 1 mm in diameter, or from about 0.2 mm to about 0.6 mm in diameter.

Conduction heating is also increased by increasing the thickness of the layer of flux composition 6 applied to the surface of the alloy containing material 4. As thickness of the layer of the flux composition 6 increases the thickness of the resulting molten slag blanket 16 also increases, which further enhances absorption of the energy beam 10 and reduces direct radiant heating of the alloy containing material 4 and the melt pool 22. The thickness of the layer of the flux composition 6 typically ranges from about 3 mm to about 25 mm. In some cases the thickness ranges from about 5 mm to about 20 mm, while in other instances the thickness ranges from about 7 mm to about 15 mm.

The flux composition 6 may also be formulated to contain laser absorptive materials, which increase absorption of the energy beam 10, and/or laser reflective materials, which tend to reflect and scatter the energy beam 10. Including laser absorptive and/or reflective materials in the flux composition 6 further reduces direct radiant heating of the alloy containing material 4 and the melt pool 22. Examples of such materials include photo-reflective metals and photo-absorbing polymers.

The flux composition may be formulated to contain at least one of the following components: (i) a high-temperature vehicle; (ii) a plasma-generating agent; (iii) a viscosity enhancer; (iv) a shielding agent; (v) a scavenging agent; and (vi) a vectoring agent. As explained above, in some embodiments the flux composition 6 does not contain fluidity enhancers. For example, in some cases the flux composition 6 does not contain a metal fluoride. In other instances the flux composition 6 does not contain a fluoride-containing compound.

High-temperature vehicles include metal oxides and metal silicates, such as alumina (Al₂O₃), silica (SiO₂), zirconia (ZrO₂), titanium oxide (TiO₂), vanadium oxide (VO₂), manganese oxide (Mn₃O₄), niobium oxide (NbO₂), sodium silicate (Na₂SiO₃), and potassium silicate (K₂SiO₃), and natural or synthetic resins, such as rosins (e.g., abietic acid, pimaric acid) and other resinous acids, as well as other high-temperature compounds that melt in the presence of an energy beam or plasma to form relatively low density slag layers which float on the surface of the melt pool 22 and are capable of acting as oxygen barriers to protect the melt pool 22 from oxidation. Plasma-generating agents include ionic compounds, such as lithium oxide (Li₂O), sodium oxide (Na₂O) and magnesium oxide (Mg₂O), and other compounds that are readily ionized by an energy beam to form a plasma. Viscosity enhancers include metal oxides, such as Al₂O₃, TiO₂, Sc₂O₃, Cr₂O₃, Y₂O₃, ZrO₂, HfO₂, La₂O₃, Ce₂O₃ and CeO₂, and other compounds known to increase viscosity of slag layers or having high melting temperatures (e.g., greater than 2100° C.) and tending to enhance early solidification of slag layers. Shielding agents include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO3)₃) and other agents known to form shielding and/or reducing gases (e.g., CO, CO₂, H₂). In some cases the flux materials may contain organic compounds capable of generating shielding gases when heated (e.g., carbo-hydrates such as cellulose).

Scavenging agents include metal oxides such as calcium oxide (CaO), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂), metal halides such as magnesium chloride (MgCl₂), sodium chloride (NaCl), and potassium chloride (KCl), and other agents known to react under high temperature (plasma) conditions with detrimental elements such as sulfur and phosphorous (in some alloy systems) and Ca, Ce, Li, Na and Yt (for magnesium-based alloys) to form low-density byproducts expected to “float” into a resulting slag layer. In some embodiments the flux composition 6 includes a scavenging agent which reacts upon heating to remove nitrogen (N₂), hydrogen (H₂), or both, from the melt pool 22. Such scavenging agents can be advantageous for magnesium alloy processing in some embodiments. Such agents are selected to include elements which, when combined with nitrogen and hydrogen in an ionized state, react to form low density nitrogen-containing and/or hydrogen-containing compounds that float into the molten slag blanket 16 and ultimately become trapped in the solidified slag crust 24.

In some embodiments the flux composition 6 is formulated to include compounds that react with nitrogen in an ionized state to form metal nitrides. Such compounds include, for example, titanium compounds (e.g., TiCl₂), vanadium compounds (e.g., VCl₂), chromium compounds (e.g., CrCl₂), zirconium compounds (e.g., ZrCl₄), niobium compounds (e.g., NbCl₅), molybdenum compounds (e.g., Mo₂Cl₁₀) tantalum compounds (e.g., TaCl₅), tungsten compounds (e.g., WCl₆). In some embodiments the flux composition 6 is formulated to include salt fluxing agents such as MgCl₂, NaCl, KCl, and mixtures of these and other metal halides which are capable of reacting with metallic impurities in magnesium alloys to remove such metal impurities in the resulting slag layer.

Vectoring agents include titanium, zirconium and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), nickel titanium alloys (e.g., Nitinol), niobium oxides (NbO, NbO₂, Nb₂O₅) and other metal-containing compounds and materials used to supplement molten alloys with elements.

In some embodiments the flux composition contains: (a) a metal oxide, a metal silicate, or both; (b) a shielding agent which decomposes upon heating to form at least carbon monoxide, carbon dioxide, or a mixture thereof; and (c) a plasma-generating agent—but does not contain a metal fluoride.

In other embodiments the flux composition contains: (a) at least one selected from the group consisting of Al₂O₃, SiO₂, Sc₂O₃, TiO₂, VO₂, Cr₂O₃, Y₂O₃, ZrO₂, NbO₂, HfO₂, La₂O₃, Ce₂O₃, CeO₂, Na₂SiO₃ and K₂SiO₃; (b) a metal carbonate; and (c) at least one selected from the group consisting of Li₂O, Na₂O and Mg₂O—but does not comprise a fluoride-containing compound.

In other embodiments the flux composition contains (a) at least one selected from the group consisting of Sc₂O₃, Cr₂O₃, Y₂O₃, ZrO₂, HfO₂, La₂O₃, Ce₂O₃ and CeO₂; and (b) at least one selected from the group consisting of CaCO₃, Al₂(CO₃)₃, NaAl(CO₃)(OH)₂, CaMg(CO₃)₂, MgCO₃, MnCO₃, CoCO₃, NiCO₃ and La₂(CO₃)₃; and (c) (c) at least one selected from the group consisting of Li₂O, Na₂O and Mg₂O—but does not contain a fluidity enhancer.

In some embodiments flux compositions of the present disclosure include:
5-60% by weight of at least one of Al₂O₃, SiO₂, Sc₂O₃, TiO₂, VO₂, Cr₂O₃, Mn₃O₄, Y₂O₃, ZrO₂, NbO₂, HfO₂, La₂O₃, Ce₂O₃, CeO₂, Na₂SiO₃ and/or K₂SiO₃;
10-50% by weight of at least one of Li₂O, Na₂O and/or K₂O;
1-30% by weight of at least one of CaCO₃, Al₂(CO₃)₃, NaAl(CO₃)(OH)₂, CaMg(CO₃)₂, MgCO₃, MnCO₃, CoCO₃, NiCO₃ and/or La₂(CO₃)₃;
15-30% by weight of at least one of CaO, MgO and/or MnO; and
0-5% by weight of at least one of Ti, Al and/or CaTiSiO₅,
   but does not contain a metal fluoride.

In some embodiments the flux compositions of the present disclosure include:
5-60% by weight of at least one of Al₂O₃, Sc₂O₃, Cr₂O₃, Y₂O₃, ZrO₂, HfO₂, La₂O₃, Ce₂O₃, CeO₂, Na₂SiO₃ and/or K₂SiO₃;
1-30% by weight of at least two of CaCO₃, Al₂(CO₃)₃, NaAl(CO₃)(OH)₂, CaMg(CO₃)₂, MgCO₃, MnCO₃, CoCO₃, NiCO₃ and/or La₂(CO3)₃;
15-30% by weight of at least one of CaO, MgO, MnO, ZrO₂ and/or TiO₂; and
0-5% by weight of at least one of Ti, Al, TiO₂ and/or CaTiSiO₅,
   but does not contain a metal fluoride.

In some embodiments the flux compositions of the present disclosure include:
5-40% by weight of Al₂O₃;
5-30% by weight of SiO₂;
1-25% by weight of at least one of Y₂O₃, ZrO₂ and/or HfO₂;
1-30% by weight of at least one of CaCO₃, MgCO₃ and/or MnCO₃;
15-30% by weight of at least two of CaO, MgO, MnO and/or TiO₂; and
0-5% by weight of at least one of Ti, Al, CaTiSiO₅, Al₂(CO₃)₃ and/or NaAl(CO₃)(OH)₂,
   but does not contain a metal fluoride.

In some embodiments the flux compositions of the present disclosure include:
5-30% by weight of Al₂O₃;
5-30% by weight of SiO₂;
1-25% by weight of ZrO₂;
1-30% by weight of at least one of CaCO₃, Al₂(CO₃)₃, NaAl(CO₃)(OH)₂, CaMg(CO₃)₂, MgCO₃ and/or MnCO₃;
15-30% by weight of at least one of CaO, MgO, MnO and/or TiO₂; and
0-5% by weight of at least one of Ti, Al, TiO₂ and/or CaTiSiO₅,
   but does not contain a metal fluoride.

In some embodiments the flux compositions of the present disclosure include zirconia (ZrO₂) and at least one other high-temperature vehicle, plasma-generating agent, shielding agent, or mixture thereof. In such cases the content of zirconia may be greater than about 7.5 percent by weight and less than about 25 percent by weight. In other cases the content of zirconia is greater than about 10 percent by weight and less than 20 percent by weight. In still other cases the content of zirconia is greater than about 3.5 percent by weight, and less than about 15 percent by weight. In still other cases the content of zirconia is between about 8 percent by weight and about 12 percent by weight.

In some embodiments the flux compositions of the present disclosure include at least two metal carbonates. For example, in some instances the flux materials include calcium carbonate and at least one of magnesium carbonate and manganese carbonate. In other cases the flux materials include calcium carbonate, magnesium carbonate and manganese carbonate. Some flux compositions comprise a ternary mixture of calcium carbonate, magnesium carbonate and manganese carbonate such that a proportion of the ternary mixture is equal to or less than 30% by weight relative to a total weight of the flux material. A combination of such carbonates (binary or ternary) is beneficial in scavenging multiple tramp elements and also producing shielding gases including carbon monoxide and carbon dioxide.

All of the percentages (%) by weight enumerated above are based upon a total weight of the flux composition being 100%.

Another novel feature of the present disclosure involves controlling the intensity and trajectory of the energy beam 10 to reduce direct radiant heating of the alloy containing material 4 and the melt pool 22. The energy beam 10 may be a laser beam such as a continuous laser beam, a pulsed laser beam, one or more circular laser beams, a scanned laser beam (scanned one, two or three dimensionally), an integrated laser beam, a diode laser beam, or the energy beam may be another energy source such as an electron beam, an ion beam, a plasma beam, etc.

In some embodiments the intensity of the energy beam 10 may be reduced by employing a laser beam having a laser wavelength which is marginally or poorly absorbed by the alloy containing material 4. It is known that volatile elements exhibit different absorption characteristics for commonly-employed laser wavelengths such as 503 nm (“Green” Nd:YAG laser), 1.06 μm (Nd:YAG and Ytterbium fiber laser) and 10.6 μm (CO₂ laser). Use of low-power-enabled laser sources such as solid-state lasers (e.g., Nd:YAG lasers) and fiber lasers (e.g., Ytterbium fiber lasers) can also be useful for reducing the degree of direct radiant heating of the alloy containing material 4 and the melt pool 22. The intensity of the energy beam 10 may also be reduced by controlling the power, focusing and dimensions of the scanning area, and also by controlling the traversal speed of the energy beam. Attenuating the power or density of the energy beam 10 reduces the amount of radiant heating of the alloy containing material 4 and the melt pool 22, leading to reduced volatility and improved mechanical characteristics (e.g., less cracking) in the solidified alloy 26. Increasing the traversal speed also reduces the applied energy and, thereby, reducing the amount of radiant heating, leading to reduced volatility and improved mechanical characteristics.

The trajectory of the energy beam 10 can also be altered to modulate the amount of direct radiant heating of the alloy containing material 4 and the melt pool 22. As shown in the FIGURE, the angle 12 of the energy beam 10 relative to the surface of the flux composition 6 may be reduced to alter both the shape of the resulting molten slag blanket 16 and the amount of radiant energy delivered to the flux composition 6 and the molten slag blanket 16. In the non-limiting illustration of the FIGURE the energy beam is a tilted laser beam adjusted to impact the surface of the flux composition 6 at an angle less than 90 degrees relative to the surface of the flux composition 6. Reducing the angle 12 can affect both the shape of the resulting molten slag blanket 16 and the proportion of radiant heating of the alloy containing material 4.

As illustrated in the FIGURE, reducing the angle 12 can alter the shape of the resulting molten slag blanket 16 to produce a concave depression under the plasma 14 and a convex hump 20 over the melt pool 22. In some embodiments the increased height of the molten slag blanket 16 in the vicinity of the convex hump 20 is believed to reduce evaporation of volatile elements in the melt pool 22 by reducing gas permeability and by increasing pressure applied to the melt pool 22. Even a small increase in pressure is expected to significantly reduce evaporation of volatile elements, given the boiling points of such elements. Reducing the angle 12 also increases the distance of travel of the energy beam through the flux composition 6 and the molten slag blanket 16 leading to increased radiant heating of the flux and slag layers with correspondingly reduced radiant heating of the alloy containing material 4 and the melt pool 22. In some embodiments the angle 12 ranges from about 30 degrees to about 80 degrees, relative to the surface (plane) of the layer of the flux composition 6. In other cases the angle 12 ranges from about 40 degrees to about 70 degrees. In still other instances the angle 12 ranges from about 45 degrees to about 65 degrees.

Under certain conditions it is believed that one or more of the above-described features can affect a temporary pressurization of the melt pool 22 by generating a pocket of gas 36 located between the molten slag blanket 16 and the melt pool 22. The presence of sufficient quantities of at least one shielding gas 18 confined within and/or beneath a viscous slag blanket 16 is expected to account at least in part for the improved physical properties of the resulting solidified alloy 26. These improved properties include reduced porosity and inclusions (both in terms of the size and concentration of gas-containing pores and oxide-containing inclusions), as well as a reduction in unwanted mechanical imperfections (weld solidification cracking and liquation cracking).

The exemplary process of the FIGURE can be adapted to accomplish a variety of different tasks involving the melting and re-solidification of volatile alloys. Such tasks include laser powder deposition and cladding of volatile alloys, additive manufacturing of three-dimensional objects containing volatile alloys, laser joining (welding) of volatile alloys, and surface modification of volatile alloys, as well as other melting/solidification tasks.

Some embodiments, for example, involve laser powder deposition of volatile alloys to produce cladding layers or cast objects containing the volatile alloys. To accomplish laser cladding, the alloy containing material 4 may be in the form of a filler material 4 containing the volatile alloy 8 which is first deposited onto a surface of a metallic substrate 2. The flux composition 6 is then deposited onto the surface of the filler material 4 and the energy beam 10 is traversed over the surface of the flux composition 6 to accomplish the melting and re-solidification of the volatile alloy 8 as described above. In such cases the resulting solidified alloy 26 is in the form of a cladding layer 26 bonded to the surface of the metallic substrate 2.

In some cases the flux composition 6 may be in the form of a multi-layered flux in which separate flux layers contain different flux materials. For example, a multi-layered flux may include a lower flux layer containing the flux composition 6 as described above and an upper flux layer containing the high-temperature metal oxide as described above. In other cases the filler material 4 may contain both the volatile alloy 8 and a flux composition. In still other cases the filler material 4 may contain both the volatile alloy 8 and a shielding agent that forms at least one shielding gas (e.g., CO, CO₂, H₂) when heated.

The flux composition 6 may also be in the form of a preform constructed of separate compartments and/or layers containing different flux compositions—in which the compartments and/or layers are constructed of, and bound together, with organic and/or inorganic materials suitable as flux materials. Embodiments may also employ preforms constructed of a lower compartment containing the filler material 4 and at least one upper compartment containing a flux composition. Such preforms can be used advantageously to form three-dimensional objects containing volatile alloys by laser additive manufacturing.

To accomplish laser casting of volatile alloys, the filler material 4 may be deposited onto the surface of a fugitive support material 2, and the laser cladding process described above is carried out to produce the solidified alloy 26, which is later separated from the fugitive support material 2 to produce an object containing a volatile alloy. “Fugitive” means removable after formation of the solidified alloy 26, for example, by direct (physical removal), by a mechanical process, by draining, by fluid flushing, by chemical leaching and/or by any other known process capable of separating the fugitive support material 2 from the solidified alloy 26. Any high-temperature material or structure capable of providing support and then being removable after the formation of the solidified alloy 26 may serve as the fugitive support material 2. In some embodiments the fugitive support material 2 may be in the form of a refractive container or bed of at least one material selected from a metal, a metallic powder, a metal oxide powder, a ceramic powder and a powdered flux material.

Volatile alloys produced by methods of the present disclosure benefit from an ability to control to a certain extent the grain structure of the solidified alloy 26 through directional solidification. The FIGURE also depicts the optional use of a solidification mold 28 (left-hand portion shown) containing a mold bottom portion 30 and a mold side portion 32. Selecting, for example, refractory materials of relatively low or high thermal conductivity allows directional control of heat transfer during cooling of the melt pool 22—such that the resulting solidified alloy 26 may contain either uniaxial (columnar) or equiaxed grain structures. In the non-limiting illustration of the FIGURE, for example, the mold bottom portion 30 may be constructed of a material of high thermal conductivity (e.g., graphite) and the mold side portion 32 may be constructed of a material of low thermal conductivity (e.g., zirconia), which arrangement causes directional solidification to produce uniaxial grains 34 oriented perpendicular to the plane of the mold bottom portion 30. By controlling the thermal conductivity of the bottom and side portions 30,32 of the refractory solidification mold 28, the grain structure of the resulting solidified alloy 26 can be customized and varied. Directional solidification can also be affected by employing at least one chill plate (not shown in the FIGURE) situated to contact the mold bottom portion 30 and/or the mold side portion 32. Heating plates may also be situated on the bottom and/or side portions of the solidification mold 28 to adjust the direction of heat transfer during cooling of the melt pool 22.

Both directional solidification and the formulation of the flux composition 6 can also be used in conjunction to reduce porosity in the solidified alloy 26 by controlling the direction of heat transfer during cooling of the melt pool 22. As shown in the illustration of the FIGURE, solidification of the melt pool 22 may be controlled such that initial solidification of the alloy 26 occurs near the surface of the support material 2 and progresses in upward direction towards the molten slag blanket 16 and/or the solidified slag crust 24. Controlling the direction of solidification in this manner can lead to reduced porosity in the resulting solidified alloy 26. It is believed that reduced porosity may occur because directional solidification tends to push existing voids upward thus reducing porosity as the solidification progresses. Factors affecting directional solidification include the thermal characteristics of the mold bottom and side portions 30,32 as explained above, as well as the thermal characteristics of the molten slag blanket 16 and the solidified slag crust 24. Formulating the flux composition 6 such that the molten slag blanket 16 and the solidified slag crust 24 exhibit higher thermal conductivities (e.g., relative to graphite) can reduce porosity in the resulting solidified alloy 26. In this regard, the inclusion of low thermal conductivity materials such as zirconia in the flux composition 6 can lead to a reduced porosity in some embodiments.

Laser joining and welding of volatile alloy substrates may also be performed by depositing a filler material 4 in a groove or joint formed by juxtaposing two or more volatile-alloy-containing substrates 2, then depositing the flux composition 6 onto the surface of the filler material 4, followed by laser powder processing as described above. Surface modification of volatile alloys may also be performed by adding or injecting hardening particles (e.g., oxides, nitrides, carbides) into the melt pool 22, such that the resulting alloy 26 exhibits increased mechanical strength or corrosion resistance.

The laser processing methods and materials disclosed herein can provide a number of advantages with respect to known processing methods involving melting and re-solidification of magnesium, zinc and other alloys containing volatile elements. First, due to the shielding effect of the flux compositions, the use of inert gases (He, N₂, Ar) is reduced and in some embodiments is avoided altogether—while still reducing or eliminating unwanted oxide inclusions in the resulting alloys. Second, due to the combined pressurization effect of the flux composition, the generated plasma and the shielding gases, the present methods may be performed under atmospheric conditions without the use of an overpressurization chamber—while still reducing the loss of volatile metal content in the resulting alloys. Third, due to the ability to control the magnitude and mode of heat applied to the volatile alloy, as well as the combined pressurization effect described above, resulting alloys exhibit lower porosity both in terms of the size and the concentration of pores. In some embodiments the porosity of the resulting volatile alloys is less than 5 percent by volume. In other cases the porosity is less than 3 percent by volume. In still other cases the porosity is less than 2 percent by volume. This advantage also often avoids the need to perform vacuum degassing on volatile alloy substrates and materials prior to laser processing. Fourth, the use of controlled heating in conjunction with removal of unwanted TRAMP elements reduces the occurrence of unwanted cracking or material degradation in the resulting alloys.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A flux composition, comprising:
a metal oxide, a metal silicate, or both;
a shielding agent which decomposes upon heating to form at least carbon monoxide, carbon dioxide, or a mixture thereof; and
a plasma-generating agent,
wherein the flux composition does not comprise a metal fluoride.

2. The flux composition of claim 1, comprising:
at least one selected from the group consisting of Al₂O₃, SiO₂, Sc₂O₃, TiO₂, VO₂, Cr₂O₃, Y₂O₃, ZrO₂, NbO₂, HfO₂, La₂O₃, Ce₂O₃, CeO₂, Na₂SiO₃ and K₂SiO₃;
a metal carbonate; and
at least one selected from the group consisting of Li₂O, Na₂O and Mg₂O,
wherein the flux composition does not comprise a fluoride-containing compound.

3. The flux composition of claim 1, comprising:
at least one selected from the group consisting of Sc₂O₃, Cr₂O₃, Y₂O₃, ZrO₂, HfO₂, La₂O₃, Ce₂O₃ and CeO₂;
at least one selected from the group consisting of CaCO₃, Al₂(CO₃)₃, NaAl(CO₃)(OH)₂, CaMg(CO₃)₂, MgCO₃, MnCO₃, CoCO₃, NiCO₃ and La₂(CO₃)₃;
at least one selected from the group consisting of Li₂O, Na₂O and Mg₂O,
wherein the flux composition does not comprise a fluidity enhancer.

4. The flux composition of claim 1, comprising at least 7.5 percent by weight of zirconia.

5. The flux composition of claim 1, further comprising a scavenging agent which reacts upon heating to remove N₂, H₂, or both, from a molten metal alloy.

6. A process, comprising:
(i) applying an energy beam to a flux composition such that
the flux composition reacts upon contact with the energy beam to form a plasma and a shielding gas,
an amount of energy applied to the flux composition is controlled to convert the flux composition into a molten slag blanket in the presence of the shielding gas without completely melting an alloy material situated below the flux composition, and
the molten slag blanket then heats and melts the alloy material by thermal conduction in the presence of the shielding gas to form a pressurized melt pool of the alloy material;
(ii) allowing the molten slag blanket to cool and at least partially solidify into a solid slag layer covering the pressurized melt pool; and
(iii) allowing the pressurized melt pool to cool and solidify into an alloy layer covered by the solid slag layer.

7. The process of claim 6, wherein the alloy material comprises a magnesium-based alloy, a zinc-based alloy, an aluminum alloy containing magnesium, a copper alloy containing cadmium, or a copper alloy containing zinc or lead.

8. The process of claim 6, wherein:
the alloy material is a powdered filler material comprising a base alloy of at least one metal selected from the group consisting of magnesium, zinc, cadmium, selenium, sodium, potassium, antimony and lead; and
the alloy layer is a metal deposit comprising the base alloy.

9. The process of claim 8, further comprising:
before step (i), pre-placing or feeding the powdered filler material onto a surface of a fugitive support material, such that the metal deposit solidifies upon the surface of the fugitive support material; and
after step (iii), removing the fugitive support material from the metal deposit to obtain an object comprising the base alloy.

10. The process of claim 6, wherein the flux composition comprises a metal carbonate which decomposes upon heating to form the shielding gas.

11. The process of claim 6, wherein the flux composition is in the form of a powder adapted to absorb radiant energy from the energy beam.

12. The process of claim 6, wherein the flux composition comprises a metal oxide having a melting point equal to or greater than 2100° C., such that a solid crust of the metal oxide forms over the molten slag blanket before the molten slag blanket solidifies into the solid slag layer.

13. The process of claim 6, wherein the energy beam is applied to a surface of the flux composition as a tilted laser beam situated such that laser energy impacts the flux composition at an angle of less than 90 degrees from the surface of the flux composition.

14. A process, comprising:
(1) pre-placing or feeding the flux composition of claim 1 onto a surface of an alloy material;
(2) heating the flux composition with an energy beam to form a molten slag blanket covering a melt pool of the alloy material in the presence of the carbon monoxide, the carbon dioxide, or the mixture thereof; and
(3) allowing the molten slag blanket and the melt pool to cool and solidify to form an alloy layer covered by a solid slag layer,
wherein:
the melt pool comprises at least one metal selected from the group consisting of magnesium, zinc, cadmium, selenium, sodium, potassium, antimony and lead; and
the process does not occur in an externally-pressurized container or in the presence of a flowing inert gas.

15. The process of claim 14, wherein the alloy material is in the form of a powdered filler material comprising a magnesium-based alloy, a zinc-based alloy, an aluminum alloy containing magnesium, a copper alloy containing cadmium, or a copper alloy containing zinc or lead.

16. The process of claim 15, further comprising:
before step (1), pre-placing or feeding the powdered filler material onto a surface of a fugitive support material, such that the alloy layer solidifies on the surface of the fugitive support material; and
after step (3), removing the fugitive support material from the alloy layer to obtain an object comprising the alloy material.

17. The process of claim 16, wherein the fugitive support material is in the form of a refractive container or a bed of at least one selected from the group consisting of a metallic powder, a metal oxide powder, a ceramic powder and a powdered flux material.

18. The process of claim 14, wherein:
the alloy material is in the form of a powdered filler material situated on a surface of at least one metallic substrate comprising a magnesium-based alloy, a zinc-based alloy, aluminum alloy containing magnesium, a copper alloy containing cadmium, or a copper alloy containing zinc and/or lead; and
the alloy layer is a cladding layer bonded to the surface of the metallic substrate or a weld joint connecting at least two metal substrates.

19. The process of claim 14, wherein a thickness of the flux composition on the surface of the alloy material ranges from 4 to 20 mm.

20. A process, comprising laser melting a volatile alloy in contact with a flux composition, followed by cooling, to form an alloy layer covered by a solid slag layer, wherein a thermal conductivity of the flux composition is effective to cause an upward directional solidification of the alloy layer such that a porosity of the alloy layer is less than 5 percent by volume.
